(19) United States
(12) Patent Application Publication
(10) Pub. No.: US 2019/0111367 A1
(43) Pub. Date: Apr. 18, 2019

(54) FILTER INSERT AND FILTRATION ARRANGEMENT HAVING A FILTER INSERT

(71) Applicant: KUENZEL advanced weaving technologies GmbH, Muenchberg (DE)

(72) Inventor: Ludwig Kuenzel, Regnitzlosau (DE)

(21) Appl. No.: 16/162,778

(22) Filed: Oct. 17, 2018

(30) Foreign Application Priority Data
Oct. 18, 2017 (DE) 102017124251.1

(51) Int. Cl. B01D 39/16; B01D 46/00

(52) U.S. Cl. CPC B01D 39/1607; B01D 39/1692; B01D 46/0005; B32B 5/022; B01D 2201/04; B01D 2201/31; B01D 46/0019

(57) ABSTRACT

A cylindrical or tubular filter insert (10) of a filter material (2) for liquid media (7) is disclosed. A filtration arrangement (30) serves to receive the cylindrical or tubular filter insert (10). The filtration arrangement (30) comprises a filter housing (31) with an inlet (32) for the medium (7) to be filtered and an outlet (34) for the filtered medium (7).

### CROSS-REFERENCE TO RELATED APPLICATIONS

This patent application claims the benefit under 35 U.S.C. § 119 of German Patent Application No. 10 2017 124 251.1, filed Oct. 18, 2017, which application is incorporated herein by reference.

### FIELD OF THE INVENTION

The present invention relates to a filter insert for liquid media. The filter insert comprises essentially a cuboid filter material, which comprises a composite nonwoven layer of several individual nonwoven layers, which are composed of a plurality of endless (continuous) fibers. The endless fibers are interconnected, wherein the plurality of endless fibers of each nonwoven layer are connected in a material-locking manner to a defined degree with other endless fibers. The endless fibers of a nonwoven layer engage in adjacent nonwoven layers and are also connected according to the defined degree with the endless fibers of the adjacent individual nonwoven layers.

Furthermore, the invention relates to a filtration arrangement for liquid media. The filtration arrangement comprises a filter housing having an inlet for the medium to be filtered and an outlet for the filtered medium. A filter insert for the filter housing has substantially a height of the filter housing. The filter insert comprises at least one elastically deformable single element, which is formed from a substantially cuboid filter material. The filter material is composed of a plurality of individual nonwoven layers of a plurality of endless fibers, which are interconnected.

### BACKGROUND OF THE INVENTION

For small and medium sized pools, whirlpools, etc. there are cylindrical filters which are exchanged and disposed of after use or at the end of the life of the filter.

German Patent Application DE 198 06 924 A1 relates to a liquid filter, in particular water filter for swimming pools, swimming pools or the like, in which at least one container is arranged, the container being filled with a loose bed of sand, gravel and/or activated carbon. The container has a water inlet into which the water to be filtered is supplied by means of a pump. The filtered water is returned to the pool via a water outlet. As a container for the filter material, a sack or bag made of a fine-pored fabric is used, its mesh size is smaller than the smallest particle size of the bed.

German Utility Model No. DE 200 10 675 U1 discloses a cartridge filter for swimming pools with interchangeable filter insert. The filter material used can be removed from the filter body and cleaned. A new or cleaned filter fleece can be installed by simply rolling up.

German Patent Application No. DE 11 2009 000 742 T5 also discloses a replaceable filter insert with removal function. The replaceable filter cartridge has a filter medium which is arranged in a zig-zag shape between two end caps.

German Patent No. DE 11 2011 102 094 T5 discloses modular filter elements for use in a filter-in-filter cartridge. There is provided for this purpose an outer filter element and an inner filter element which can be assembled to form a filter cartridge for use in deposition methods and systems. The outer filter element usually functions as a coalescing element, and the inner element usually functions as a particle filter element.

German Utility Model No. DE 20 2011 109 098 U1 discloses a filter for filtering media with a pleated, cylindrical filter element which is arranged between a perforated cylindrical backflow preventer and a perforated cylindrical core. The filter element is arranged in pleated folds with a plurality of pleats having a first pleat height that is greater than the difference between the radius of the backflow preventer and the radius of the core. The pleated folds are directed away from the outer surface of the core and each inclined by a tilt angle with respect to a radial.

German Utility Model No. DE 20 2012 003 179 U1 discloses self-supporting structures with adsorptive properties. The adsorptive structure comprises a plurality of individual adsorber particles. The individual adsorber particles are connected by means of at least one hydrocolloid to form a self-supporting three-dimensional adsorptive structure, in particular an adsorptive shaped body.

German Utility Model No. DE 20 2015 101 238 U1 discloses a filter insert with a plurality of filter networks, each having a plurality of fibers. The fiber networks can be flowed through by a liquid. The fiber networks are arranged in a bag, which itself can be flowed through by liquid.

European Patent No. EP 1 736 049 B1 discloses an internal filter device for aquariums for purifying water. The internal filter device comprises a housing with a housing bottom, a ceiling region and suction openings, wherein a filter element is accommodated in the housing, which has a suction channel for conveying water. The suction channel has a first upper end which can be fluidly connected to a suction device, wherein the housing has a first region having the suction openings for sucking the water from the aquarium, wherein the first region is spatially separated from a second area for receiving the filter element by a substantially vertically extending liquid-tight partition wall.

German Patent No. DE 10 2016 108 558 B3 discloses a filter material for liquid media from a plurality of individual nonwoven fabric layers. Each nonwoven fabric layer comprises a plurality of endless fibers which are interconnected in a material-locking manner to a defined degree with other endless fibers. Likewise, adjacent nonwoven layers are connected to some degree with the adjacent nonwoven layers and thereby form a composite nonwoven layer having a defined top side and bottom side. The filter material of the composite nonwoven layer is cut into geometric filter bodies having the top side and bottom side of the composite nonwoven layer.

German Patent Application No. DE 39 40 264 A1 discloses a multilayer filter material made of nonwoven fabrics. The filter material is made of fibers or filaments of the same or different polymers.

A construction manual for a pond filter can be taken from the website www.teich-filter.eu/teichfilter-aufbau-reihenfolge-filtermedien so that the best possible effect is achieved. The correct order of the filter media and the structure of the pond filter are extremely important. It is crucial which filter media gets into which filter chamber so that the cohesion of the coarse filtering, biological filtering, mechanical filtering and fine filtering can take place at all.

### SUMMARY OF THE INVENTION

It is an object of the present invention to provide a filter insert that is effective, efficient and reliable in terms of its filtration properties and at the same time cost-effective, easy to change and sustainable.

This object is achieved by a filter insert for a filtration arrangement for filtering liquid media, wherein a cuboid filter material of the filter insert is composed of a composite nonwoven layer of a plurality of individual nonwoven layers of a plurality of endless fibers, which are interconnected, wherein the plurality of endless fibers of each nonwoven layer are interconnected to a defined degree with other endless fibers, and wherein the endless fibers of a nonwoven layer engage in adjacent nonwoven layers and are likewise connected in accordance with the defined degree with the endless fibers of the adjacent individual nonwoven layers, wherein the filter insert comprises at least one elastically deformable single element, wherein the at least one elastically deformable single element is formed from the cuboid filter material, and wherein the at least one elastically deformable single element has an outer diameter which is larger than a diameter of a filter housing, so that the at least one elastically deformable single element rests against an inner wall of the filter housing, the inner wall defining an inner space.

A further object of the invention is to provide a filtration arrangement for liquid media which is effective, reliable, easy to expand, cost effective and sustainable in its use in filtration properties for the liquid medium to be filtered.

This object is achieved by a filtration arrangement for liquid media comprising a filter housing with an inlet for the medium to be filtered and an outlet for the filtered medium, a filter insert for the filter housing, the filter insert having substantially a height of the filter housing and comprising at least one elastically deformable single element, which is formed of a substantially cuboid filter material, wherein the filter material is composed of a plurality of individual nonwoven layers of a plurality of endless fibers, which are interconnected, wherein the at least one elastically deformable single element has an outer diameter which is greater than a diameter of the filter housing, so that the at least one elastically deformable single element rests at least against an inner wall of the filter housing, the inner wall defining an inner space.

The filter insert for liquid media according to the invention comprises at least one elastically deformable single element. The at least one elastically deformable single element is formed from a cuboid filter material. The at least one single element has an outer diameter that is larger than a diameter of a filter housing. This ensures that the at least one elastically deformable single element rests against an inner wall of the filter housing, wherein the inner wall defines an inner space.

A further possible embodiment of the filter insert or of the single element may be that the filter insert has a cylindrical shape.

According to a possible further embodiment, the at least one cylindrical single element may be cut from the elastically deformable filter material along a cutting line. The individual nonwoven layers are aligned perpendicularly to a longitudinal axis of the cylindrical single element.

According to a possible embodiment, the filter insert or the at least one single element can be configured to be tubular. The filter insert or the at least one single element defines an outer surface and an inner surface.

The nonwoven layers are arranged parallel to each other in the cuboid filter material as well as in the operational tubular filter insert or single element. In one possible embodiment of the tubular filter insert or single element, the nonwoven layers run parallel to one another and are arranged substantially concentrically to a longitudinal axis of the tubular filter insert or the tubular single elements.

According to an embodiment of the filter insert, the tubular single elements may comprise at least one cuboid filter material formed into a tube. According to a further possible embodiment, the cuboid filter material, from which the tubular single elements are formed, can be configured such that at least two of the nonwoven layers of the cuboid filter material differ in terms of material density.

According to a possible embodiment, in the production of the tubular single elements, that nonwoven layer with the lower material density is aligned with the jacket of the tubular single element. The nonwoven layer with the greater material density is aligned towards the core of the tubular single element. The nonwoven layers with the different material density can be distinguished with a corresponding color code (such as, for example, coloring of the nonwoven layer). It should be noted at this point that it is not absolutely necessary that the larger weight per unit area (grammage) is attached to the outside of the tubular single element. As described above, the coarser version of the cuboid filter material should be attached to the outside of the single element. A coarse material may well be finer than a higher weight per unit area (grammage) material. This can be adjusted via different material densities and an additional compaction. Thus, a filter material with a weight per unit area (grammage) of 500 grains per square meter can filter coarser than a filter material with a weight per unit area (grammage) of only 300 grams per square meter, but which is more compressed. This results in smaller passages in the filter material despite the lower material density.

According to possible embodiments, the cylindrical or tubular single element can be cut from the cuboid filter material. The nonwoven layers are then substantially perpendicular to a cutting line through the cuboid filter material.

A plurality of tubular single elements can be stacked along a longitudinal axis to form the operational filter insert, since the height of the cylindrical or tubular single elements does not always correspond to the required total height of the operational filter insert.

At least one stabilizing means is provided, so that the cylindrical or tubular single element retains its shape for transport, storage and/or handling. The stabilizing means may have various configurations. Mixed forms of the stabilizing means can also be used for the stabilization of the cylindrical or tubular single element.

The filter insert may also include a bag configured to conform to the shape of the cylindrical single element. The bag is made of a net-like (mesh-like, reticular) material permeable to the medium to be filtered. The bag is formed closeable. According to a possible embodiment, a zipper is provided for closing.

The bag may also be made of the filter material having the plurality of adjacent individual nonwoven layers. The closeable bag can be filled with multiple geometric filter bodies.

The endless (continuous) fibers of the filter material are preferably made of polyester. The endless fibers of the filter material are made from 60% to 90% of solid (full) or hollow fibers and from 10% to 40% of melt fibers. The endless fibers may have a round and oval cross-sectional shape. The filter material made of the endless fibers has a weight per unit area (grammage) of 250 g to 1800 g per square meter. It is also conceivable that the weight per unit area (grammage) of the filter material varies from nonwoven layer to nonwoven layer. The endless fibers may have a fiber thickness of about 40 microns.

The filter material according to the invention is advantageous because it allows three-dimensional filtering for the medium to be filtered. This three-dimensional filtering is provided by the fact that the individual endless fibers within each nonwoven layer also extend in all three dimensions. Therefore, the medium to be filtered must travel along a three-dimensional path through the filter material. Thus, a sufficient distance is provided for the filtering of the medium to be filtered in order to effectively filter the particle-loaded medium to be filtered. In addition, the filter material according to the invention can simply be washed out and thus can be used again for reuse for filtering. Likewise, the special design of the filter material for the circulation pump enables a smaller design or the circulating pump can be operated with a lower power, which in turn leads to energy savings.

The filtration arrangement for liquid media according to the invention is characterized in that a filter housing is provided with an inlet for the liquid medium and an outlet for the filtered medium. The filtration arrangement has a filter insert in the filter housing that has substantially a height of the filter housing. The filter insert comprises at least one elastically deformable single element, which is formed from a substantially cuboid filter material. The filter material is composed of a plurality of individual nonwoven layers of a plurality of endless fibers which are interconnected. According to the invention, the at least one elastically deformable single element has an outer diameter which is larger than a diameter of the filter housing. As a result, the at least one elastically deformable single element rests at least against an inner wall of the filter housing, wherein the inner wall defines an inner (interior) space.

According to one embodiment of the invention, a receptacle for the filter insert is provided in the filtration arrangement. The receptacle comprises an outer cylindrical wall, which is permeable to the medium to be filtered, and an inner cylindrical wall. An operable tubular filter insert is seated between the outer cylindrical wall and the inner cylindrical wall, wherein the operable tubular filter insert comprises at least one tubular single element and substantially has a height of the receptacle.

According to a possible embodiment, the filter insert may comprise at least one cylindrical single element.

According to a possible embodiment, the at least one cylindrical single element may be surrounded by a bag which has the shape of the cylindrical single element. The bag is made of a net-like material permeable to the medium to be filtered, and the bag is formed closeable.

According to a possible embodiment, the filter insert may comprise a permeable bag of net-like (reticulated) material for the medium to be filtered. A plurality of geometric filter bodies cut from the filter material can be filled into the bag. The bag is closeable after filling.

The filled bag may be shapeable such that it rests against the inner wall of the filter housing, the inner wall defining the interior space.

The cylindrical or tubular filter insert provides three-dimensional filtering for the medium to be filtered. This three-dimensional filter property is achieved by the three-dimensional arrangement of the individual endless fibers in the individual nonwoven layers. The endless fibers may have a round and/or oval cross-sectional shape. The filter material can have a weight per unit area (grammage) of 250 g to 1800 g per square meter. The weight per unit area (grammage) may vary within the cuboid filter material.

A further embodiment of the filtration arrangement according to the invention is that the tubular filter insert is seated in the filtration arrangement. The tubular filter insert is configured such that the filter insert is surrounded by an outer cylindrical stabilization means and an inner cylindrical stabilization means. The outer cylindrical stabilization means has formed a plurality of passages, so that the medium to be filtered can reach the filter material of the filter insert. The inner cylindrical stabilization means has formed a plurality of passages, so that the filtered liquid medium can pass out of the filtration arrangement. In this embodiment of the filtration arrangement, the outer cylindrical stabilization means corresponds to an outer cylindrical wall of the receptacle, and the inner cylindrical stabilization means corresponds to the inner cylindrical wall of the receptacle.

A further possibility of the configuration of the filtration arrangement is that the filter insert is inserted directly into the filter housing of the filtration arrangement. The filter insert is shapeable or configured such that the filter insert rests against an inner wall of the filter housing, wherein the inner wall defines an interior space. The filter insert for the medium to be filtered is positioned between the inlet and the outlet. This ensures that the medium to be filtered meets filter material during the filtration process. In this embodiment, the filter insert may comprise at least one cylindrical single element. The at least one cylindrical single element can be surrounded by a bag Which has the shape of the cylindrical single element. The bag is made of a material permeable to the medium to be filtered, and the bag is configured to be closeable.

The filter insert for the filtration arrangement may also comprise a bag made of a material permeable to the medium to be filtered. A plurality of geometric filter bodies cut from the filter material can be filled into the bag. The bag is also configured to be closed after filling. The filled bag may be shaped to abut the inner wall of the filter housing of the filtration arrangement, wherein the inner wall defines the interior space.

### BRIEF DESCRIPTION OF THE DRAWINGS

The nature and mode of the operation of the present invention will now be more fully described in the following detailed description of the invention taken with the accompanying drawing figures, in which:

FIG. 1 is a schematic sectional view through a composite nonwoven layer used according to the present invention;

FIG. 2 is an enlarged view of the filter material with the schematic representation of the inclusion of dirt particles;

FIG. 3 is a schematic side view of a cuboid filter fleece, from which the tubular filter insert can be made;

FIG. 4 is a schematic view of an embodiment of a geometrically shaped body which has been produced from the filter material (composite nonwoven layer);

FIG. 5 is a plan view of the upper surface of the filter material, wherein a cutting line for the cylindrical filter insert or a cylindrical single element for the cylindrical filter insert is indicated;

FIG. 6 is a perspective view of the cut-out cylindrical filter insert or the cylindrical single element for the cylindrical filter insert;

FIG. 7 is a perspective view of the arrangement of a plurality of cylindrical single elements for the cylindrical filter insert;

FIG. 8 is a schematic view of a filtration arrangement for filtering liquid media;

FIG. 9 is a sectional view through the filtration arrangement of FIG. 8 with a cylindrical filter insert inserted;

FIG. 10 is a plan view of the upper surface of the filter material, wherein a cutting line for the tubular filter insert or a tubular single element for the tubular filter insert is indicated;

FIG. 11 is a perspective view of the cut-out tubular filter insert or tubular single element for the tubular filter insert;

FIG. 12 is a perspective view of the arrangement of a plurality of tubular single elements for the tubular filter insert;

FIG. 13 is a perspective view of the tubular filter insert or a tubular single element which is seated in a receptacle according to an embodiment;

FIG. 14 is a plan view of a tubular filter insert or a tubular single element, in which the individual nonwoven layers are arranged concentrically;

FIGS. 15A and 15B are different views of a releasable connection for producing the tubular filter insert;

FIGS. 16A and 16B are different views of the permanent connection for producing the tubular filter insert;

FIG. 17 is a perspective view of a receptacle for the tubular filter insert;

FIG. 18 is a schematic sectional view of a filtration arrangement using the tubular filter insert of the present invention;

FIG. 19 is a sectional view of a further possible embodiment of a configuration of the filter insert;

FIG. 20 is a sectional view of an additional possible embodiment of a configuration of the filter insert;

FIG. 21 is a view of a partial section of a possible embodiment of a configuration of the filter insert; and,

FIG. 22 is a view of a partial section of a further possible embodiment of a configuration of the filter insert.

### DETAILED DESCRIPTION OF EMBODIMENTS OF THE INVENTION

For identical or equivalent elements of the invention, identical reference numerals are used. It will be understood by those skilled in the art that the embodiments of the filtration arrangement and the tubular filter body presented in the description are not intended to be limiting of the invention. The size ratios in the figures do not always correspond to the actual size ratios, as some shapes are simplified and other shapes are shown enlarged in relation to other elements for ease of illustration.

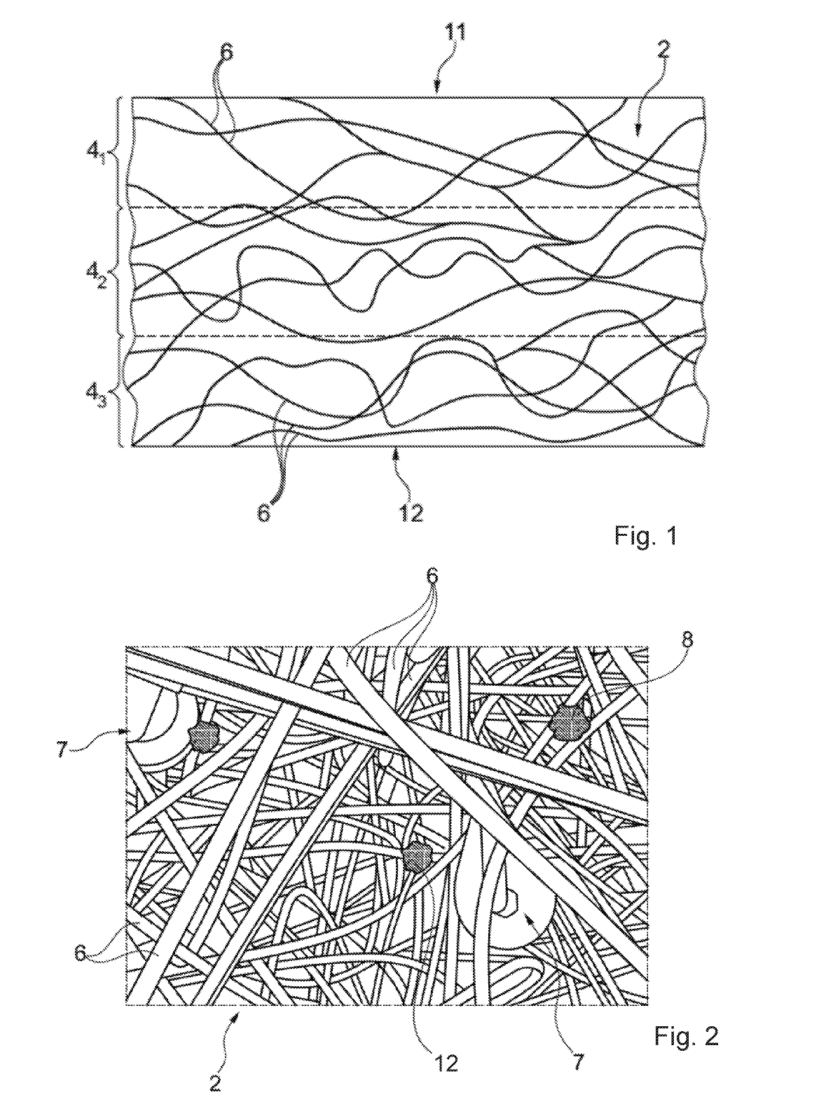

FIG. 1 shows a schematic view of a filter material 2. In the representation shown herein, a filter material 2 comprises three individual nonwoven layers 4₁, 4₂ and 4₃. It should be appreciated that the representation chosen herein and the structure of filter material 2 chosen herein should not be construed as limiting the invention. Filter material 2 can be configured with any number of nonwoven layers 4₁, 4₂, . . . , 4_{N} depending on the requirements of the filter properties or the mechanical properties. Individual nonwoven layers 4₁, 4₂, . . . , 4_{N} have a plurality of endless fibers 6, which also extend over adjacent nonwoven layers 4₁, 4₂, . . . , 4_{N}. The endless fibers 6 in the individual nonwoven layers 4₁, 4₂, . . . , 4_{N} and the endless fibers 6 which engage adjacent nonwoven layers 4₁, 4₂, . . . , 4_{N} are connected with each other in a material-locking manner to a certain extent (number of connections (crosslinks) of the endless fibers per unit volume).

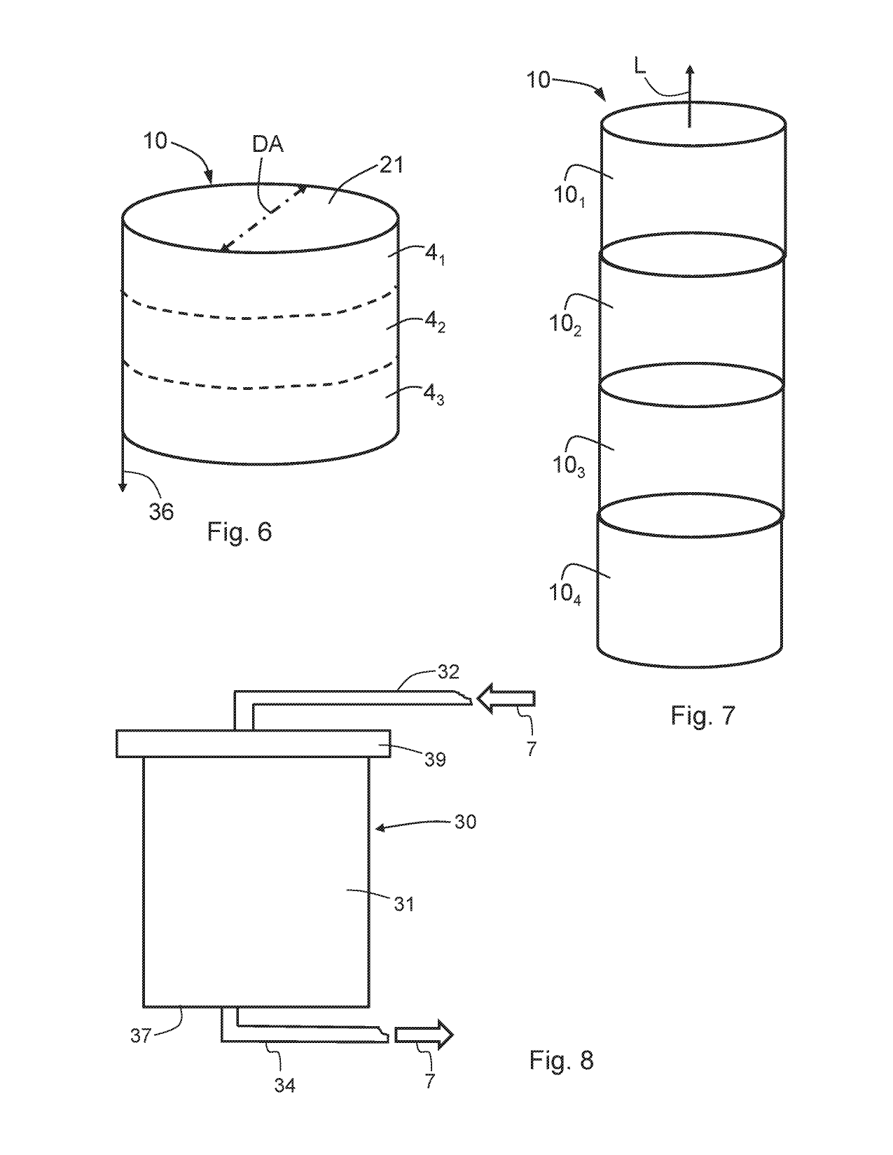

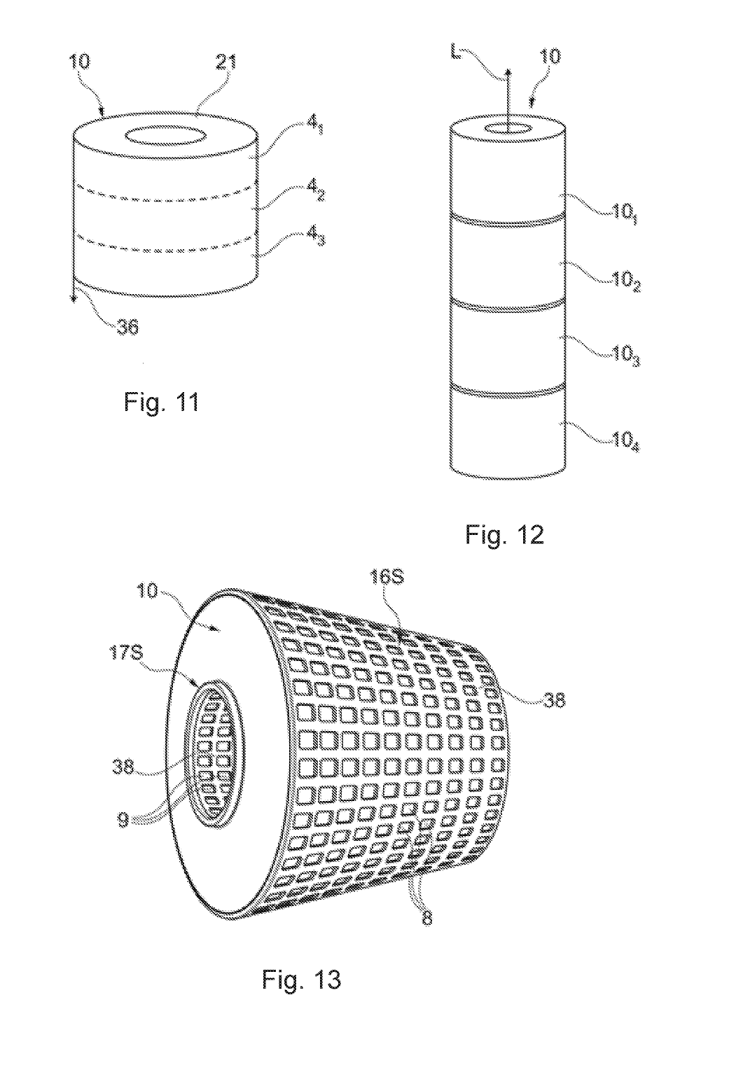

FIG. 2 shows an enlarged view of filter material 2, in which the individual endless fibers 6 are arranged confused in the filter element or in the individual nonwoven layers 4₁, 4₂, . . . , 4_{N}. The liquid medium 7 to be filtered passes between the endless fibers 6 through the filter material 2 of the individual nonwoven layers 4₁, 4₂, . . . , 4_{N}. In this case, the dirt particles 12 are released and adhere to the endless fibers 6. By this effect, a cleaning of the liquid medium 7 to be filtered is achieved. Especially due to the confused arrangement of the endless fibers 6 in the filter material 2, the medium 7 to be filtered must take a three-dimensional path through the filter material 2 or the tubular filter insert 10. The path of the medium 7 to be filtered through the filter material 2 or the filter insert 10 (tubular or cylindrical) (see FIG. 6 or 11) thus becomes long, so that effective filtering is achieved despite the low volume density of filter material 2. In addition, filter insert 10 opposes a small flow resistance to medium 7 to be filtered, which leads to cost savings in the circulating pump.

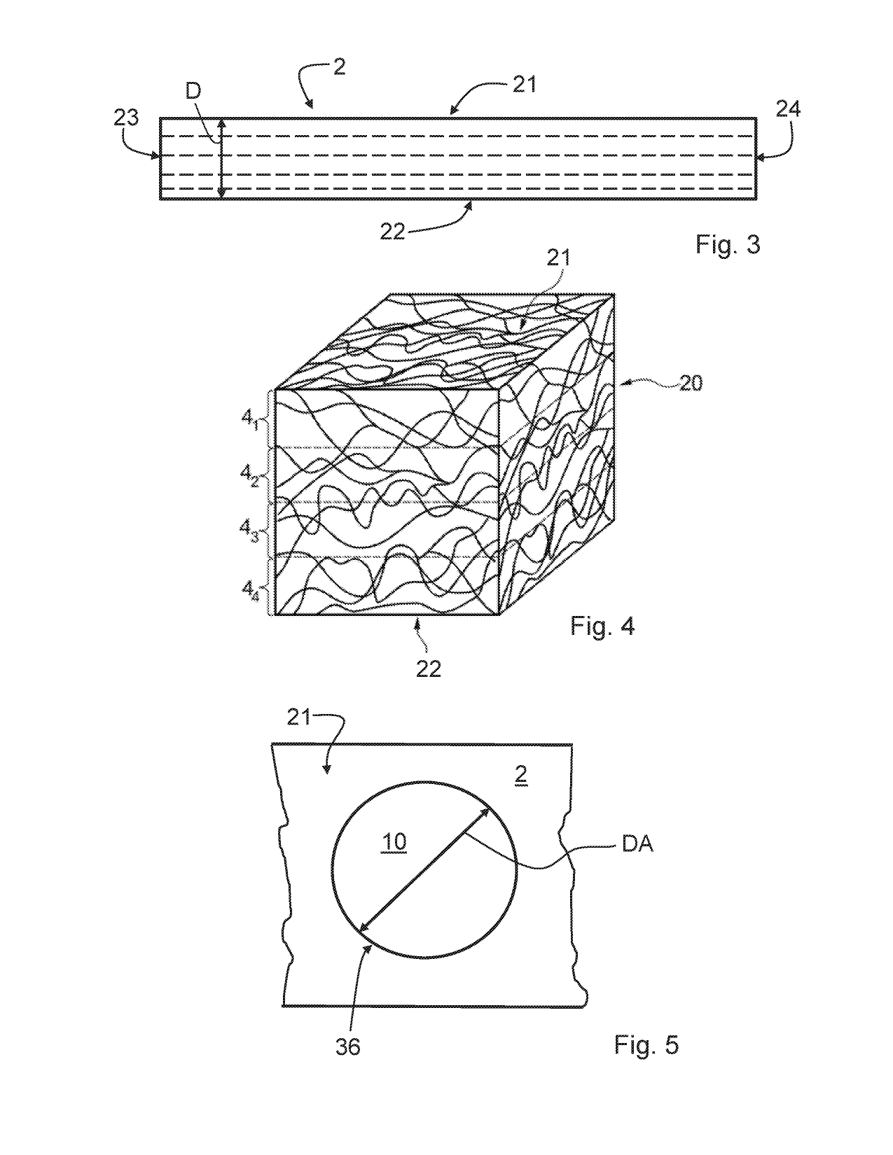

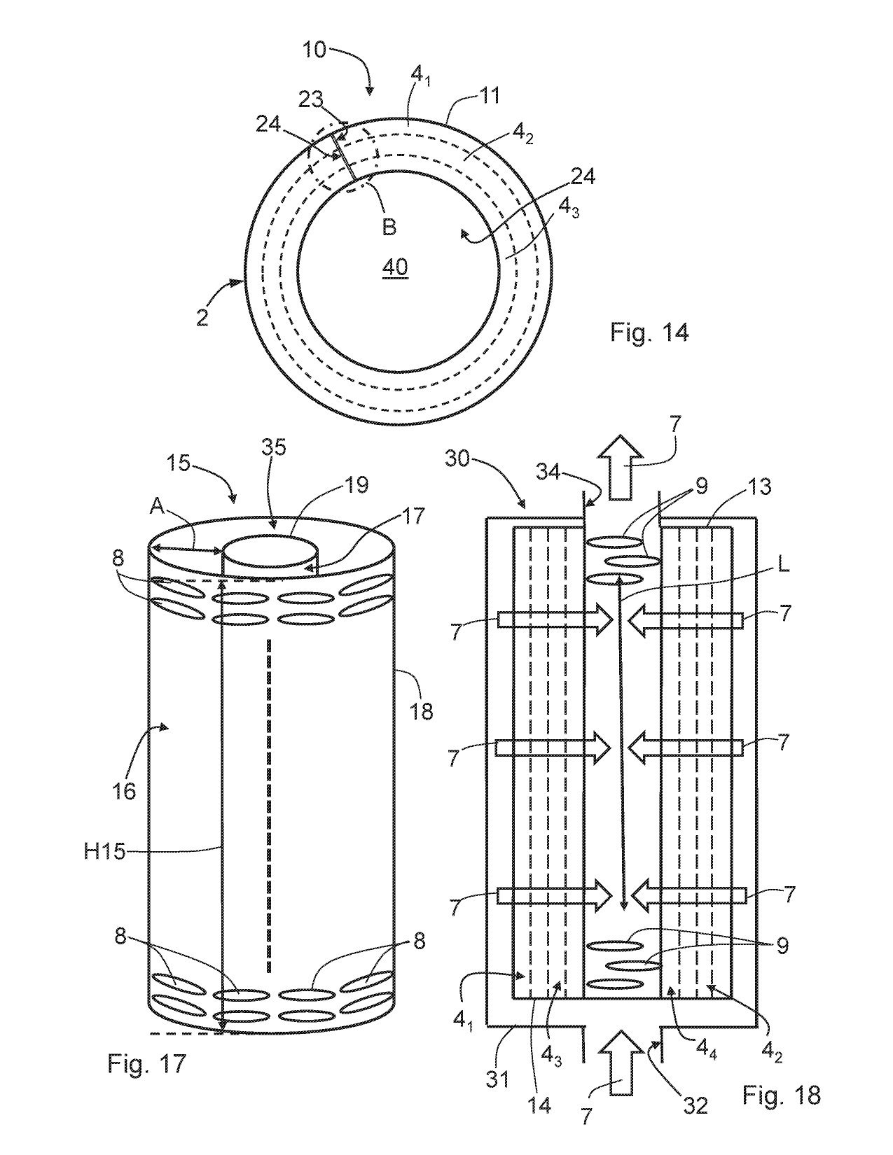

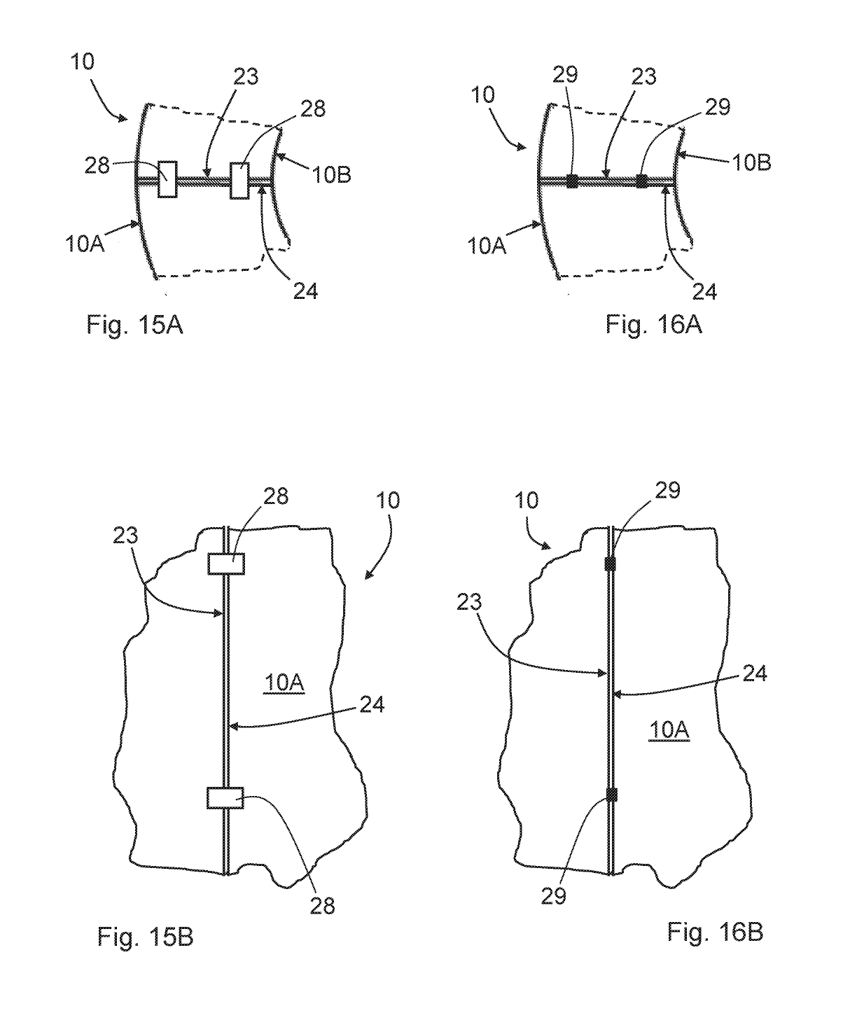

As shown in FIG. 3, the filter material 2 is substantially cuboid in shape and has an upper surface 21, a lower surface 22, a first end surface 23 and a second end surface 24. The plurality of nonwoven layers 4₁, 4₂, . . . , 4_{N} (see FIG. 4) are arranged between the upper surface 21 and the lower surface 22 and extend substantially parallel to the upper surface 21 and the lower surface 22 of the cuboid filter material 2. The filter insert 10 is formed in that the first end surface 23 and the second end surface 24 abut each other. As a result, the individual nonwoven layers 4₁, 4₂, 4₃ and 4₄ run parallel to one another and are likewise arranged concentrically to a longitudinal axis L (see FIG. 14) of the filter insert 10. The filter insert 10 thus defines an outer surface 10A extending in the direction of longitudinal axis L and also an inner surface 10B extending in the direction of longitudinal axis L (see FIGS. 15A and 16A). Although four nonwoven layers 4₁, 4₂, 4₃ and 4₄ have been described in the description of FIGS. 4 and 5, this should not be construed as limiting the invention. It should be appreciated that any number of nonwoven layers 4₁, 4₂, . . . , 4_{N} can be used for the formation of filter insert 10 or filter material 2.

FIG. 4 shows a geometric filter body 20 for the filtration of liquid media 7, in particular water. The geometric filter body 20 is cut from the filter material 2 (see FIG. 3) so that single, individual filter bodies 20 are obtained. Corresponding to the configuration of filter material 2 with the individual nonwoven layers 4₁, 4₂, . . . , 4_{N}, the geometric filter body 20 also has the corresponding number of nonwoven layers 4₁, 4₂, . . . , 4_{N}. Similarly, the geometric filter body 20 has the upper surface 21 and the lower surface 22 of the filter material 2, from which the geometric filter body 20 has been made or cut out. The particular advantage of the filter material 2 according to the invention and the filter body 20 cut out of it is the dimensional stability of filter body 20. It should also be mentioned herein that the illustrated geometric shape of filter body 20 should not be construed as limiting the invention. Filter bodies 20 of any shape and size can be cut from filter material 2. The only condition is that the cut-out filter bodies 20 must also have the upper side 21 and the lower side 22 of the filter material 2.

FIG. 5 shows a plan view of the upper surface 21 of the filter material 2. With a cutting means, not shown, a cutting line 36 for the cylindrical filter insert 10 or a cylindrical single element 10₁, 10₂, . . . , 10_{N} (see FIG. 7) for the cylindrical filter insert 10 is formed in the filter material 2. The cut-out cylindrical filter insert 10 or a cut-out cylindrical single element 10₁, 10₂, . . . , 10_{N} for the cylindrical filter insert 10 is shown in FIG. 6 in a perspective view. The cylindrical filter insert 10 comprises at least one nonwoven layer 4₁, 4₂, . . . , 4_{N}. The nonwoven layers 4₁, 4₂, . . . , 4_{N} are substantially perpendicular to a cutting line 36. The cylindrical filter insert 10 has an outer diameter DA.

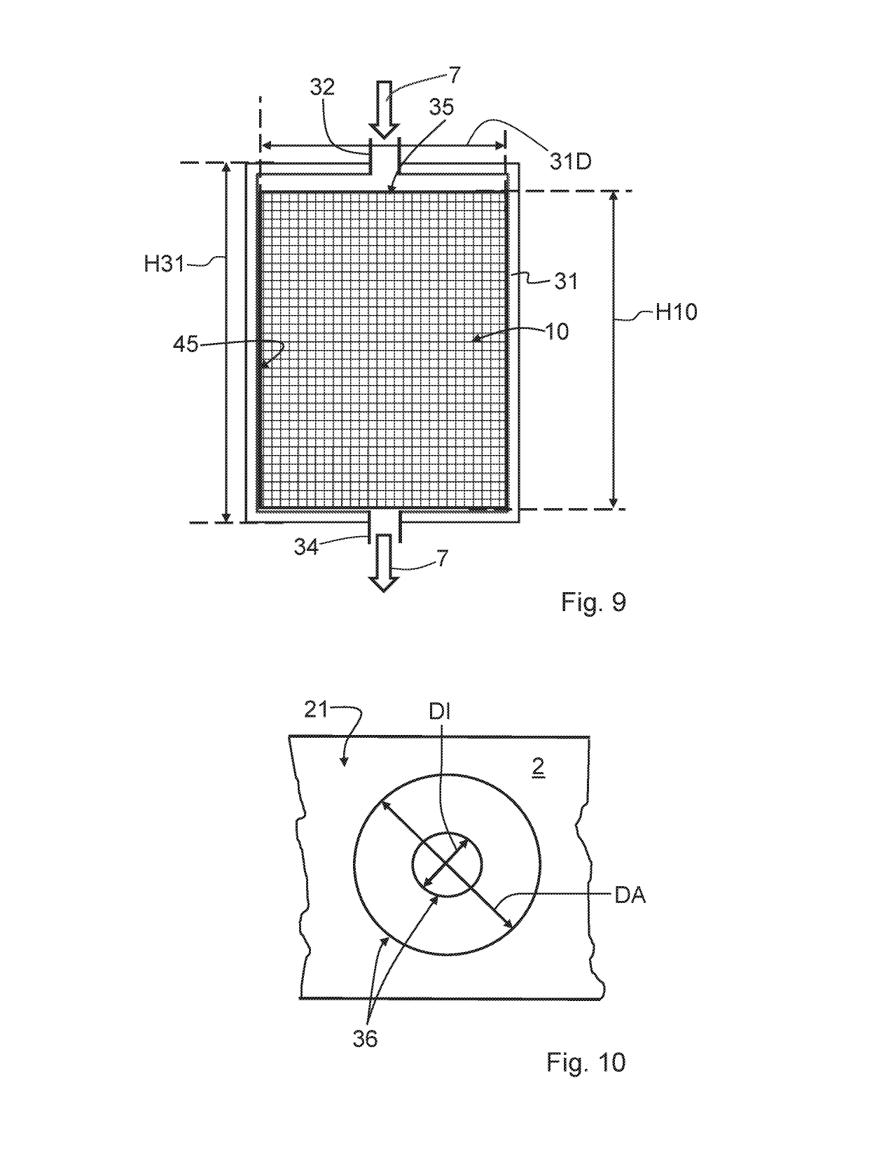

FIG. 7 shows a perspective view of an arrangement of a plurality of cylindrical single elements 10₁, 10₂, . . . , 10_{N} for the cylindrical filter insert 10. In the illustrated embodiment, four cylindrical single elements 10₁, 10₂, 10₃ and 10₄ are stacked along the longitudinal axis L of filter insert 10. It should be understood that the number of stacked cylindrical single elements 10₁, 10₂, . . . , 10_{N} should not be construed as limiting the invention. The number of cylindrical single elements 10₁, 10₂, . . . , 10_{N} required depends on the height H31 of the filter housing 31 (see FIG. 9) for the filter insert 10.

FIG. 8 shows a schematic view of a possible embodiment of a filtration arrangement 30 for filtering liquid media 7, in which the embodiment of the cylindrical filter insert according to the invention (not shown here) is used. The liquid medium 7 to be filtered is supplied to the filtration arrangement 30 via an inlet 32. The filtration arrangement 30 includes a filter housing 31 that can be closed with a lid 39. The inlet 32 ends in the lid 39. The filtration arrangement 30 is closed by a bottom 37. Starting from the bottom 37, the filtered medium 7 is discharged via an outlet 34. The filtered medium 7 may be transferred, for example, into a storage device, a swimming pool, an aquarium or the like.

FIG. 9 shows a sectional view through the filter housing 31 of the filtration arrangement 30. The filter insert 31 or the at least one single element 10₁, 10₂, . . . , 10_{N} is inserted into the filter housing 31. The filter insert 10 is seated between the inlet 32 and the outlet 34. The filter insert 10 comprising the filter material 2 is configured such that it has an outer diameter DA (see FIG. 6) which is larger than a diameter 31D of the filter housing 31. The filter housing 31 of the filtration arrangement 30 has a height H31 that is greater than or equal to a height H10 of the filter insert 10. The cylindrical filter insert 10 or the plurality of cylindrical single elements 10₁, 10₂, . . . , 10_{N} have a height H10 which is less than or equal to the height H31 of the filter housing 31 of filtration arrangement 30. The individual cylindrical filter inserts 10 may differ in terms of their weight per unit area (grammage) or the material density, so as to obtain an entire filter insert 10 having a gradation or gradient in the filtration properties.

By dimensioning the outer diameter DA of the filter insert 10, the interior space 35 of the filter housing 31 is filled. Since the filter insert 10 has a larger outer diameter 10A than the diameter 31D of the filter housing 31, the cylindrical filter insert 10, which is also elastically deformable, is in full contact over its entire surface with an inner wall 45 of filter housing 31, the inner wall 45 defining the inner space 35. This has the advantage that the medium 7 to be filtered on the way from the inlet 32 to the outlet 34 must pass exclusively the filter insert 10 and thus the filter material 2. This ensures that effective filtering of the medium 7 to be filtered is carried out. A path of the medium 7 to be filtered past the filter insert 10 is excluded.

FIG. 10 shows a plan view of the upper surface 21 of the elastically deformable filter material 2. A cutting line 36 for the tubular filter insert 10 or a tubular single element 10₁, 10₂, . . . , 10_{N} for the tubular filter insert 10 is formed in the filter material 2 with a cutting means, not shown. The cut-out tubular filter insert 10 or a cut-out tubular single element 10₁, 10₂, . . . , 10_{N} for the tubular filter insert 10 is shown in FIG. 11 in a perspective view. The nonwoven layers 4₁, 4₂, . . . , 4_{N} are substantially perpendicular to the cutting line 36. As can be seen from FIG. 10, the cut-out tubular filter insert 10 or a cut tubular single element 10₁, 10₂, . . . , 10_{N} for the tubular filter insert 10 has a Diameter DA and an inner diameter D1.

FIG. 12 shows a perspective view of the arrangement of a plurality of tubular single elements 10₁, 10₂, . . . , 10_{N} for the tubular filter insert 10. In the illustrated embodiment, four tubular single elements 10₁, 10₂, 10₃ and 10₄ are stacked along longitudinal axis L of filter insert 10. It should be understood that the number of stacked tubular single elements 10₁, 10₂, . . . , 10_{N} should not be construed as limiting the invention. The number of tubular single elements 10₁, 10₂, . . . , 10_{N} required depends on the height H15 of the receptacle 15 (see FIG. 17) for the filter insert 10.

FIG. 13 shows a perspective view of the tubular filter insert 10 which is seated, in the embodiment shown herein, between an outer cylindrical stabilization means 16S and an inner cylindrical stabilization means 17S. The receptacle 15 (see FIG. 17) is thus formed by the outer cylindrical stabilization means 16S and the inner cylindrical stabilization means 17S. The outer cylindrical stabilization means 16S comprises a plurality of passages 8, and the inner cylindrical stabilization means 17S comprises a plurality of passages 9. In the embodiment shown herein, the passages 8 and 9 are sized so that their total area is greater than the impermeable and flexible structure of the outer cylindrical stabilization means 16S and the inner cylindrical stabilization means 17S. In the embodiment shown herein, the outer cylindrical stabilization means 16S of the outer cylindrical wall 16 and the inner cylindrical stabilization means 17S of the inner cylindrical wall 1.7 correspond to a receptacle 15 (see FIG. 17).

FIG. 14 shows a plan view of a tubular filter insert 10, which is formed from at least one cuboid filter material 2. The cuboid filter material 2 of each tube 11 comprises three nonwoven layers 4₁, 4₂ and 4₃. It will be understood by one skilled in the art that the number of nonwoven layers 4₁, 4₂, . . . , 4_{N} should not be construed as limiting the invention. The number of nonwoven layers 4₁, 4₂, . . . , 4_{N} can be adjusted with respect to the specific application. As already mentioned in the description of FIG. 2, the at least one tube for the tubular filter insert 10 can be produced from the cuboid filter material 2. Tube 11 is connected via the first end surface 23 and the second end surface 24 of the cuboid filter material 2 (the manner of the connection will be explained below).

FIG. 15A and FIG. 15B show different views of how the tubular filter insert 10 is formed and maintained from the cuboid filter material 2. FIG. 15A is an enlarged view of the region indicated by B in FIG. 14. The cuboid filter material 2 is deformed in such a way that the first end surface 23 and the second end surface 24 come to rest against each other. In the embodiment shown herein, the first end surface 23 and the second end surface 24 are held together with a plurality of releasable connections 28 such that the tubular filter insert 10 retains its shape. The releasable connections 28 may be formed, for example, in the form of Velcro® hook and loop fasteners, snap locks, etc.

In the embodiment shown in FIGS. 16A and 16B, the first end surface 23 and the second end surface 24 of the cuboid filter material 2 are permanently connected to one another by permanent connections 29. FIG. 16A is an enlarged view of the region indicated by B in FIG. 14. The permanent connections 29 may be produced, for example, by laser welding, ultrasound, bonding, etc. It is also conceivable that a mixture of releasable connections 28 and permanent connections 29 may also be provided in order to stabilize the tubular filter insert 10 in its shape. In the embodiments shown herein, the releasable connections 28 and/or permanent connections 29 are mounted on the outer surface 10A of tubular filter insert 10, respectively. It will be understood by one skilled in the art that this is not intended to be a limitation of the invention as claimed. Of course, the releasable connections 28 as well as the permanent connections 29 may also be provided on the inner surface 10B of the tubular filter insert.

FIG. 17 is a perspective view of a receptacle 15 for the tubular filter insert 10, which, for example, has no outer cylindrical stabilization means 16S and no inner cylindrical stabilization means 17S. The receptacle 15 has a height H15 and comprises an outer tube 18 and an inner tube 19. The tubular filter insert 10 is provided between the inner tube 19 and the outer tube 18. Outer cylindrical wall 16 of outer tube 18 has a plurality of passages 8, so that the medium 7 to be filtered (see FIG. 2) can reach tubular filter insert 10. Inner tube 19 has also formed a plurality of passages 9 (see FIG. 18), so that the filtered medium 7 passes from tubular filter insert 10 through inner cylindrical wall 17 of inner tube 19. The dashed line is intended to illustrate that the passages 8 extend over the entire outer cylindrical wall 16. The same applies to the passages 9 in the inner cylindrical wall 17. Between inner tube 19 and outer tube 18, an inner space 35 is formed, which serves in the embodiment described herein for receiving the tubular filter insert 10 and the at least one single element 10₁, 10₂, . . . , 10_{N} . By means of the dimensioning of the outer diameter DA of filter insert 10, the interior space 35 of filter housing 31 is filled. Since filter insert 10 has a larger outer diameter DA than the diameter 31D of the filter housing 31, tubular filter insert 10, which is also elastically deformable, is in full contact over its entire surface on an inner wall 45 (see FIG. 9) of filter housing 31, the inner wall 45 defining the inner space 35.

FIG. 18 shows a schematic sectional view of a filtration arrangement 30 according to the present invention. The receptacle 15 (see FIG. 17) for the tubular filter insert 10 is seated in a filter housing 31. The filter housing 31 has an inlet 32 for the medium 7 to be filtered. The medium 7 to be filtered passes to the tubular filter insert 10 via the inlet and the passages 8 in the outer tube 18. The medium 7 to be filtered enters the interior space of the inner tube 19 via corresponding passages 9, which are formed in the inner cylindrical wall 17 of inner tube 19. From there, the filtered medium 7 can be drained via an outlet 34 formed by inner tube 19. The filtered medium 7 can thus be returned to the pool, whirlpool, or the like. Essentially, the medium 7 to be filtered flows through the tubular filter insert 10 in a direction substantially perpendicular to the longitudinal axis L of the receptacle 15 for the tubular filter insert 10.

The material for receptacle 15 of tubular filter insert 10 may be, for example, a thermoplastic or a metal. A preferred material for the receptacle 15 may be stainless steel. The passages 8 and 9 for the outer tube 18 and the inner tube 19, respectively, can be introduced by means of laser cutting or punching in the case of stainless steel. The receptacle 15 has a bottom 14 on which the inner tube 19 is seated and thus closed in the direction of the inlet 32. In the direction of the outlet 34, the inner tube 19 is open, so that the filtered medium 7 can be removed from the filtration arrangement 30. The receptacle 15 is closed in the region of the outlet 34 by an annular cover 13, so that the outlet 34 remains free out of the inner tube 19. Through the bottom 14 and the annular cover 13 of the receptacle 15 it is achieved that the medium 7 to be filtered in the filtration arrangement 30 flows through from the outer cylindrical wall 16 from annular filter insert 10 to the inner cylindrical wall 17 and thus provides effective filtering in the tubular filter insert 10.

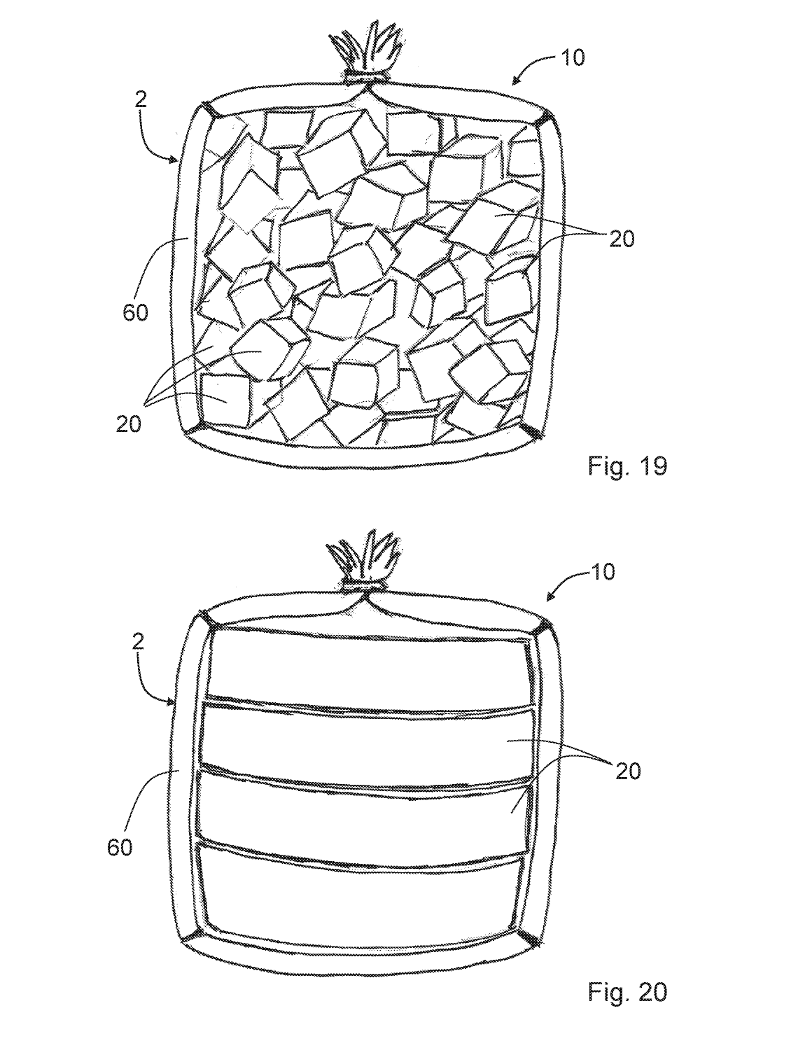

FIG. 19 shows a sectional view of a further possible embodiment of the filter insert 10. The filter insert 10 comprises a bag 60. The bag 60 can be made of the filter material 2 with one nonwoven layer 4₁ or of the filter material 2 with the plurality of adjacent individual nonwoven layers 4₁, 4₂, . . . , 4_{N}. In this case, the bag 60 is made such that it substantially corresponds to the shape of the filter housing 31. The bag 60 is filled with a plurality of geometric filter bodies 20. The geometric filter bodies 20 are cuboid in the embodiment described herein. The filter bodies 20 are cut from the filter material 2 with the several adjacent individual nonwoven layers 4₁, 4₂, . . . , 4_{N}. The number of geometric filter bodies 20 is selected such that they fill the bag 60 and the bag 60 assumes a stable shape, which can substantially fill the interior space of the filter housing 31.

FIG. 20 shows a sectional view of an additional possible embodiment of the design of filter insert 10. Again, the bag 60 may be made of the filter material 2 with one nonwoven layer 4₁ or of the filter material 2 with the plurality of adjacent individual nonwoven layers 4₁, 4₂, . . . , 4_{N}. The bag 60 is filled with geometric filter bodies 20 which are cylindrical. The filter bodies 20 are also cut from the filter material 2 with the several adjacent individual nonwoven layers 4₁, 4₂, . . . , 4_{N}. The number of geometric filter bodies 20 is selected to fill the bag 60. The individual cylindrical filter bodies 20 may differ in weight per unit area (grammage) or material density. Thus, for example, a fitter body 20 with low weight per unit area (grammage) or material density may be provided directly after the inlet 32 (see FIG. 17) for the medium 7 to be filtered. The weight per unit area of the filter bodies 20 may increase in the filter insert 10 from the inlet 32 towards the outlet 34. With the grading of the weight per unit area (grammage) or the material density, a gradation of the filtration properties of the filter insert 10 is thus achieved.

The bag 60 shown in FIGS. 19 and 20 can be permanently closed after being filled with the geometric filter bodies 20. Likewise, the bag 60 can be configured such that it can be opened to replace the filter bodies 20. For bag 60, it is recommended according to the invention to use a filter material 2, which has a lower, or at least the same, weight per unit area (grammage) or material density than the geometric filter bodies 20 provided in the bag 60.

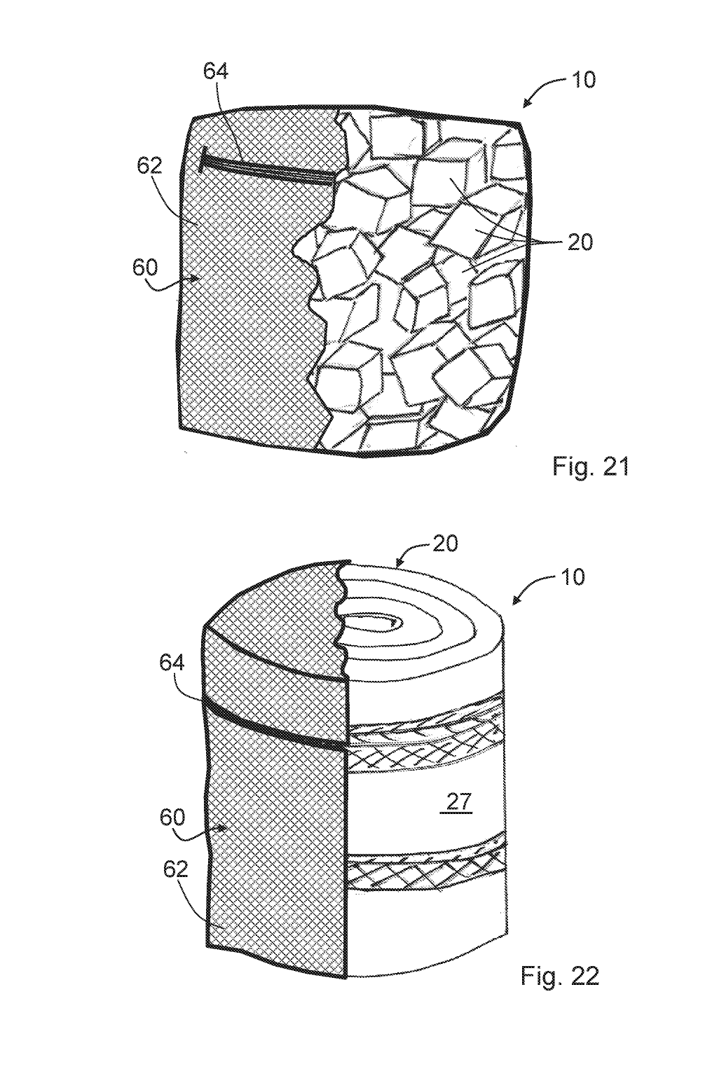

FIG. 21 shows, in a partial section, a view of a possible embodiment of the design of the filter insert 10. The bag 60 for accommodating the geometric filter bodies 20 is made of a net-like material 62 permeable to the medium 7 to be filtered. After filling with the geometric filter bodies 20, the bag 60 may be closed, for example, with a zipper 64. The closed bag 60 may be shaped to fit into the filter housing 31.

FIG. 22 shows in a partial section a view of a possible embodiment of the design of the filter insert 10. The bag 60 for accommodating the geometric filter body 20, which has the shape of a cylinder 27, is made of a net-like material 62 which is permeable to the medium 7 to be filtered. The bag 60 is also in the shape of a cylinder. After inserting the filter body 20 into the bag 60, the bag 60 may be closed, for example, with a zipper 64. The filter body 20 or the bag 60 may be dimensioned such that it fills the filter housing 31. Also, a plurality of bags 60 may be stacked with the cylinders 27 (analogous to FIG. 13) to fill appropriately sized filter housings 31.

The invention has been described with reference to preferred embodiments. It will be understood by those skilled in the art that changes and modifications of the invention may be made without departing from the scope of the following claims.

### LIST OF REFERENCE NUMBERS

2 Filter material
4₁, 4₂, . . . , 4_{N} Nonwoven layer
6 Endless fibers
7 Medium to be filtered, filtered medium
8 Passage (opening)
9 Passage (opening)
10 Filter insert
10₁, 10₂, . . . , 10_{N} Single (individual) element
10A Outer surface
10B inner surface
11 Tube
12 Dirt particles
13 Annular cover (lid, cap)
14 Bottom
15 Receptacle
16 Outer cylindrical wall
16S Outer cylindrical stabilization means
17 Inner cylindrical wall
17S Inner cylindrical stabilization means
18 Outer tube
19 Inner tube
20 Geometric filter body
21 Upper surface
22 Lower surface
23 First end surface
24 Second end surface
27 Cylinder
28 Releasable connection
29 Permanent connection
30 Filtration arrangement
31 Filter housing
31D Diameter
32 Inlet
34 Outlet
35 Interior space, inner free space
36 Cutting line
37 Bottom
39 Lid (cover, cap)
45 Inner wall
60 Bag
62 Net-like material
64 Zipper
A Distance
B Region
DA Outer diameter
DI Inner diameter
H10 Height of filter insert
H15 Height of receptacle
H31 Height of filter housing
L Longitudinal axis
U Circumference

1. A filter insert (10) for a filtration arrangement (30) for filtering liquid media (7), wherein a cuboid filter material (2) of the filter insert (10) is composed of a composite nonwoven layer of a plurality of individual nonwoven layers (4₁, 4₂, . . . , 4_{N}) of a plurality of endless fibers (6), which are interconnected, wherein the plurality of endless fibers (6) of each nonwoven layer (4₁, 4₂, . . . , 4_{N}) are interconnected to a defined degree with other endless fibers (6), and wherein the endless fibers (6) of a nonwoven layer (4₁, 4₂, . . . , 4_{N}) engage in adjacent nonwoven layers (4₁, 4₂, . . . , 4_{N}) and are likewise connected in accordance with the defined degree with the endless fibers (6) of the adjacent individual nonwoven layers (4₁, 4₂, . . . , 4_{N}), wherein the filter insert (10) comprises at least one elastically deformable single element (10₁, 10₂, . . . , 10_{N}), wherein the at least one elastically deformable single element (10₁, 10₂, . . . , 10_{N}) is formed from the cuboid filter material (2), and wherein the at least one elastically deformable single element (10₁, 10₂, . . . , 10_{N}) has an outer diameter (DA) which is larger than a diameter (31D) of a filter housing (31), so that the at least one elastically deformable single element (10₁, 10₂, . . . , 10_{N}) rests against an inner wall (45) of the filter housing (31), the inner wall (45) defining an inner space (35).

2. The filter insert (10) according to claim 1, wherein at least one single element (10₁, 10₂, . . . , 10_{N}) is cylindrical.

3. The filter insert (10) according to claim 2, wherein the at least one cylindrical single element (10₁, 10₂, . . . , 10_{N}) is cut from the elastically deformable filter material (2) along a cutting line (36), and the individual nonwoven layers (4₁, 4₂, . . . , 4_{N}) are aligned perpendicular to a longitudinal axis (L) of the cylindrical single element (10₁, 10₂, . . . , 10_{N}).

4. The filter insert (10) according to claim 1, wherein the at least one elastically deformable single element (10₁, 10₂, . . . , 10_{N}) is tubular and has an outer surface (10A) and an inner surface (10B).

5. The filter insert (10) according to claim 4, wherein in the at least one elastically deformable tubular single element (10₁, 10₂, . . . , 10_{N}), the nonwoven layers (4₁, 4₂, . . . , 4_{N}) extend parallel to each other and radially to a longitudinal axis (L) of the tubular single element (10₁, 10₂, . . . , 10_{N}).

6. The filter insert (10) according to claim 4, wherein the at least one tubular and elastically deformable single element (10₁, 10₂, . . . , 10_{N}) is formed from at least one layer of the cuboid filter material (2).

7. The filter insert (10) according to claim 5, wherein the at least one tubular and elastically deformable single element (10₁, 10₂, . . . , 10_{N}) is formed from at least one layer of the cuboid filter material (2).

8. The filter insert (10) according to claim 4, wherein the tubular and elastically deformable single element (10₁, 10₂, . . . , 10_{N}) is cut from the cuboid filter material (2), wherein the nonwoven layers (4₁, 4₂, . . . , 4_{N}) are substantially perpendicular to a cutting line (36).

9. The filter insert (10) according to claim 4, wherein a plurality of tubular and elastically deformable single elements (10₁, 10₂, . . . , 10_{N}) are stacked along a longitudinal axis (L) and form the operational filter insert (10).

10. A filtration arrangement (30) for liquid media (7), comprising:
a filter housing (31) with an inlet (32) for the medium (7) to be filtered and an outlet (34) for the filtered medium (7),
a filter insert (10) for the filter housing (31), the filter insert (10) having substantially a height (H31) of the filter housing (31) and comprising at least one elastically deformable single element (10₁, 10₂, . . . , 10_{N}), which is formed of a substantially cuboid filter material (2), wherein the filter material (2) is composed of a plurality of individual nonwoven layers (4₁, 4₂, . . . , 4_{N}) of a plurality of endless fibers (6), which are interconnected, wherein the at least one elastically deformable single element (10₁, 10₂, . . . , 10_{N}) has an outer diameter (DA) which is greater than a diameter (31D) of the filter housing (31), so that the at least one elastically deformable single element (10₁, 10₂, . . . , 10_{N}) rests at least against an inner wall (45) of the filter housing (31), the inner wall (45) defining an inner space (35).

11. The filtration arrangement (30) according to claim 10, wherein the filter insert (10) for the medium (7) to be filtered is positioned between the inlet (32) and the outlet (34).

12. The filtration arrangement (30) according to claim 10 wherein the filter insert (10) comprises at least one cylindrical single element (10₁, 10₂, . . . , 10_{N}).

13. The filtration arrangement (30) according to claim 11 wherein the filter insert (10) comprises at least one cylindrical single element (10₁, 10₂, . . . , 10_{N}).

14. The filtration arrangement (30) according to claim 12, wherein the at least one cylindrical single element (10₁, 10₂, . . . , 10_{N}) is surrounded by a bag (60) having the shape of the cylindrical single element (10₁, 10₂, . . . , 10_{N}), being made of a net-like material (62) that is permeable to the medium (7) to be filtered, and being formed closeable.

15. The filtration arrangement (30) according to claim 13, wherein the at least one cylindrical single element (10₁, 10₂, . . . , 10_{N}) is surrounded by a bag (60) having the shape of the cylindrical single element (10₁, 10₂, . . . , 10_{N}), being made of a net-like material (62) that is permeable to the medium (7) to be filtered, and being formed closeable.

16. The filtration arrangement (30) according to claim 12, wherein the filter insert (10) comprises a bag (60) made of a net-like material (62) permeable to the medium (7) to be filtered, wherein the bag (60) is fillable with a plurality of geometric filter bodies (20) cut from the filter material (2), and wherein the bag (60) is closeable after filling.

17. The filtration arrangement (30) according to claim 13, wherein the filter insert (10) comprises a bag (60) made of a net-like material (62) permeable to the medium (7) to be filtered, wherein the bag (60) is fillable with a plurality of geometric filter bodies (20) cut from the filter material (2), and wherein the bag (60) is closeable after filling.

18. The filtration arrangement (30) according to claim 16, wherein the filled bag (60) has such a volume and is shapeable to abut the inner wall (45) of the filter housing (31), the inner wall (45) defining the inner space (35).

19. The filtration arrangement (30) according to claim 17, wherein the filled bag (60) has such a volume and is shapeable to abut the inner wall (45) of the filter housing (31), the inner wall (45) defining the inner space (35).

20. The filtration arrangement (30) according to claim 10, wherein the filter insert (10) comprises at least one tubular single element (10₁, 10₂, . . . , 10_{N}).

21. The filtration arrangement (30) according to claim 20, wherein a receptacle (15) for the filter insert (10) is provided in the filtration arrangement (30), the receptacle (15) having an outer cylindrical wall (16), which is permeable to the medium (7) to be filtered, and an inner cylindrical wall (17), and the receptacle (15) being positioned between the outer cylindrical wall (16) and the inner cylindrical wall (17) of the tubular filter insert (10).

22. The filtration arrangement (30) according to claim 20, wherein the filter insert (10) is directly inserted into the filter housing (31) of the filtration arrangement (30) and shaped such that the filter insert (10) rests against an inner wall (45) of the filter housing (31) and the filter insert (10) for the medium (7) to be filtered is positioned between the inlet (32) and the outlet (34), wherein the inner wall (45) defines an inner space (35).
